(19) United States
(12) Patent Application Publication
(10) Pub. No.: US 2007/0253286 A1
(43) Pub. Date: Nov. 1, 2007

(54) Novel Agitator for the Feed Industry

(76) Inventor: Jian Huang, Beijing (CN)

Correspondence Address: MATTHIAS SCHOLL, 14781 MEMORIAL DRIVE, SUITE 1319, HOUSTON, TX, 77079, US

(21) Appl. No.: 11/576,523

(22) PCT Filed: Sep. 5, 2005
(86) PCT No.: PCT/CN05/01403

§ 371 Date: Apr. 3, 2007

(30) Foreign Application Priority Data
Oct. 14, 2004 (CN) 200410083952.0

(51) Int. Cl. B01F 13/08

(52) U.S. Cl. 366/273

(57) ABSTRACT

A novel agitator for the feed industry is provided herein. In the middle of the agitating vessel disposed is a vertical agitating shaft (z-axis), which is installed inside the shaft liner of the vessel cover. The agitating shaft moveably fitting the shaft liner can move up and down. A handwheel shaft liner on the upper half of the vertical agitating shaft is concave-convexly moveable relative to the holes of the shaft liner. The single-side skewed teeth are mounted on the bottom face of the handwheel shaft liner and on the top face of corresponding shaft liner as well. A transmitting wheel is mounted on the lower half of the shaft liner. A driving wheel takes the torque from the electromotor by means of a belt and makes the shaft liner turn. In turn meshing the shaft liner of vessel cover, the handwheel shaft liner transmits the torque to the vertical agitating shaft to turn it. The engagement uses single-side skewed teeth which do not work when turning reversely. Therefore the handwheel shaft liner can be shaken reversely to turn the agitating shaft. One agitating head in the shape of a part of a regular cone is mounted at the lower end of the vertical agitating shaft.

### FIELD OF THE INVENTION

This invention relates to an agitator for the feed industry.

### DESCRIPTION OF THE RELATED ART

Conventional agitators used in the feed industry comprise an agitating shaft which turns around a fixed axis of rotation and a fixed bottom part, posing various problems when used in conjunction with a packing machine.

### SUMMARY OF THE INVENTION

This invention is intended to provide a new type of agitator for the feed industry, with a movable bottom and an agitating shaft which can not only turn but also move up and down. A scraper fitting is mounted additionally to diversify the functions of the agitator.

The objective of this invention is realized in the following measures: In the middle of the agitating vessel disposed is a vertical agitating shaft (Z-axis), which is installed inside the shaft liner of the vessel cover. The agitating shaft moveably fitting the shaft liner can move up and down. A handwheel shaft liner on the upper half of the vertical agitating shaft is concave-convexly moveable relative to the holes of the shaft liner. The single-side skewed teeth are mounted on the bottom face of the handwheel shaft liner and on the top face of corresponding shaft liner as well. A transmitting wheel is mounted on the lower half of the shaft liner. A driving wheel takes the torque from the electromotor by means of a belt and makes the shaft liner turn. In turn, meshing the shaft liner of the vessel cover, the handwheel shaft liner transmits the torque to the vertical agitating shaft to turn it. The engagement uses single-side skewed teeth which do not work when turning reversely. Therefore, the handwheel shaft liner can be shaken reversely to turn the agitating shaft. One agitating head in the shape of part of a regular cone is mounted at the lower end of the vertical agitating shaft.

The bottom of the agitating vessel is a moveable, round multilayer structure. Under normal operating conditions, each layer of the plate takes the form of a sector. At both endpoints and on the extension line of the diameter of the top-lay plate, there are the horizontal shafts movably fitting the relative holes in the wall of the vessel. The entire bottom of the vessel can turn around the horizontal shaft (x-axis).

The turning of the vessel bottom is driven by the torque of the rocker fixed at the end of horizontal shaft which extends out of the vessel. The expansion aligning pin on the other end of the rocker matches up the fixed pinhole pedestal on the outside of the vessel to fix the vessel bottom.

A vertical shaft mounted in the center of the undersurface of the top-layer plate moveably fits the holes in the middle-layer and the bottom-layer plates. The middle-layer and bottom-layer plates driving each other by means of the stoppers can rotate horizontally around the vertical shaft (the z-axis). The bottom-layer plate is magnetic and a rotating magnetic ring is mounted outside the agitating vessel.

A scraper mounted inside the agitating vessel being of similar shape of the inner wall can rotate around the z-axis. Correspondingly outside of the vessel is a rotating magnetic ring, which drives the bottom-layer plate and the scraper inside the vessel by means of a magnetic force.

The gears inside the agitating vessel are sealed up by a belt cover and their interface is sealed by packing material; so is the interface of the horizontal shaft and the wall of the vessel.

In accordance therwith, the agitating shaft of this novel feed agitator can move up and down and be turned by electromotion or by manual operation. A scraper mounted inside the agitating vessel provides new functions together with the moveable vessel bottom.

### BRIEF DESCRIPTION OF THE DRAWINGS

FIG. 1 is a main cross-sectional view of one embodiment;

FIG. 2 is a cross-sectional view along the A-A line thereof, and

FIG. 3 is an enlarged view of part B thereof.

### DETAILED DESCRIPTION OF THE INVENTION

This invention will be further described hereinbelow in combination with the attached figures and the concrete implementation examples.

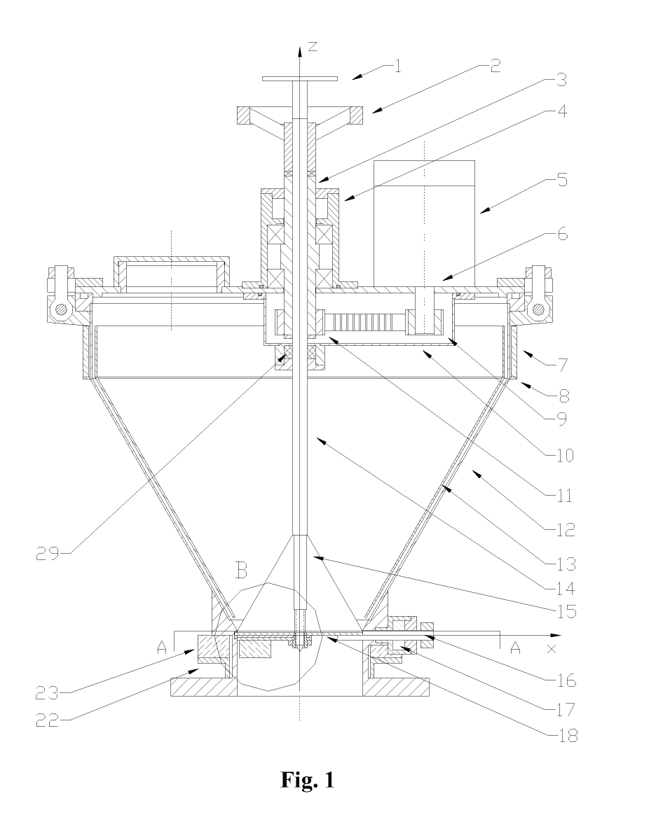

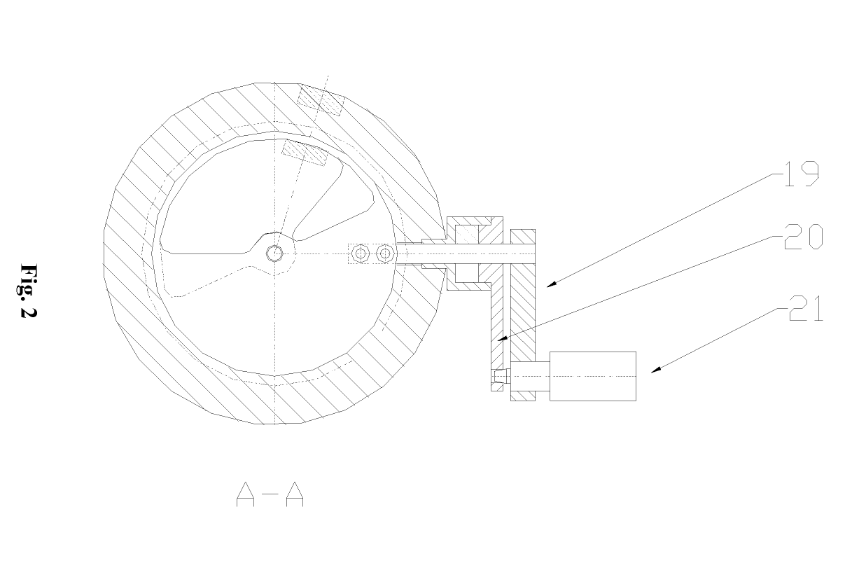

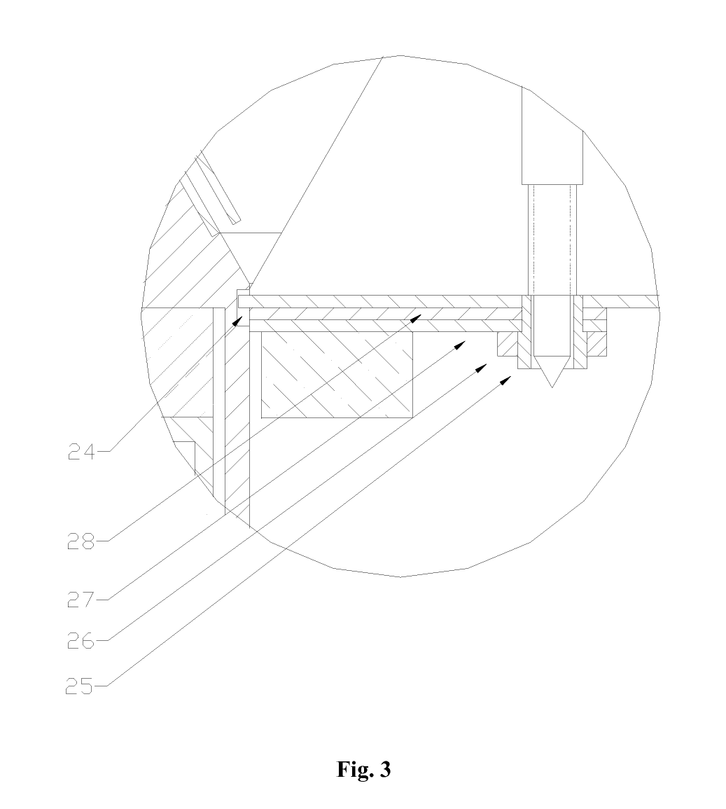

The new agitator for feed industry described in FIG. 1, FIG. 2 and FIG. 3 comprises a vertical agitating shaft 14 disposed in the middle of an agitating vessel. The agitating shaft 14 is mounted inside a shaft liner 3 having a movable fit. The shaft liner 3 and a bearing block 4 are installed on a cape hood 6. A handwheel shaft liner 2 mounted on the agitating shaft 14 is concave-convexly moveable relative to the agitating shaft 4. Skewed teeth at the lower end of handwheel shaft liner form the moveable half of the clutch and those at the upper end of the shaft liner 3 form the fixed half. When the top and the bottom skewed teeth engage, the torque of shaft liner 3 will be passed to the agitating shaft via the handwheel shaft liner 2. The lower half of shaft liner 3 and the transmitting wheel 11 have a stationary fit in a concave-convex way. The transmission wheel 11 and a driving wheel 9 form one transmission set by means of friction, engagement or belt. The electromotor passes the torque to the agitating shaft 14 to turn it via the transmission set and the clutch.

Agitating head 15 in form of a regular cone with a fan-shaped bottom is mounted at the lower end of the agitating shaft 14. The concave-convex fit and a spacer joint the agitating head 15 with the lower end of the agitating shaft.

The upper half of the agitating vessel 12 is in the shape of a cylinder barrel and the lower half in the shape of a circular truncated cone barrel. The bottom of the agitating vessel 12 is a round multilayer structure and normally works in a horizontal state. Each layer of the plate is in the shape of a sector. At both endpoints and on the extension line of the diameter of the top-lay plate 18, there are disposed horizontal shafts 16 and 24, respectively, whose axes are within the same plane as the top surface of the top-layer plate 18. The horizontal shafts have a moveable fit with the relevant holes in the walls of the vessel. The entire bottom can rotate around the horizontal shafts. The horizontal shafts 16 and 24 can be made into a united body with the top-layer plate 18, or can be firmly connected to the top-layer plate 18 by means of welding, threaded connection, adhesive binding, or a transition part.

The turning of the vessel bottom is driven by a rocker 19 fixed at the end of the horizontal shaft 16 which extends out of the agitating vessel 12. The expansion aligning pin 21 on the other end of rocker 19 matches up the fixed pinhole pedestal 20 on the outside of the vessel 12 to fix the vessel bottom.

There is a round hole in the center of top-layer plate 18 and a hollow vertical shaft 25 in the bottom center of the top-layer plate. The center hole of the top-layer plate 18, the inner hole of the vertical 25 and the bottom end of the agitating shaft 14 have a moveable fit. The external circle of the vertical shaft 25 and the round center holes of middle-layer plate 28 and bottom-layer plate 27 have also a moveable fit. The middle-layer plate 28 and the bottom-layer plate 27, which are able to turn around the vertical shaft horizontally and drive each other by the stoppers, are supported by the protruding step of the vertical shaft or protruding element 26 fixed on the vertical shaft. The bottom-layer plate 27 is made of magnetic material or attached to by one layer of magnetic material. Correspondingly outside of the agitating vessel 12 is disposed a protruding element 22, on which a magnetic ring 23 is disposed which can turn around the z-axis.

A scraper 13 in a similar shape as the inner wall of the vessel is mounted inside of the agitating vessel 12. The upper part of the scraper is in the shape of a thin-wall cylinder and the lower part consists of a plurality of thin scrapers. The scraper 13 moveably fitting the inner wall of the vessel can turn around the z-axis in a close way. The scraper 13 is made of magnetic material or attached to by one layer of magnetic material. Correspondingly outside of the agitating vessel 12 disposed is a protruding element 8, on which the magnetic ring 7 is disposed that can turn around the z-axis.

A belt cover 10 seals the transmission wheel 11, the belt, and the driving wheel 9. The joints of the agitating shaft 14 and the belt cover 10 are sealed by the packing material 29 and the joints of the horizontal shaft 16 and the walls of the agitating vessel are sealed by the packing material 17.

What is claimed is:

1. A novel agitator for the feed industry comprising agitating fitting, transmission fitting, gearing and bottom fitting; an agitating shaft (14) can go up and down inside a shaft liner (3) mounted inside a bearing block (4) on a cap hood (6); a hand wheel shaft liner (2) is mounted on upper part of said agitating shaft (14), which forms a clutch together with said hand wheel shaft liner (2) and said shaft liner (3); said shaft liner (3), a transmission wheel (11), a belt and a driving wheel (9) compose a transmission set; torque of an electromotor (5) is passed to said agitating shaft (14) to turn it (z-axis) via said transmission set and said clutch; said clutch engaging with single-side skewed teeth which do not work when turned reversely can be turned reversely by hand; an agitating head (15) in shape of regular cone is mounted in the lower half of said agitating shaft (14), on the top of which installed a blocking plate (1); the upper half of an agitating vessel (12) is in shape of cylinder barrel and the lower half in shape of circular truncated cone barrel and bottom is a round multilayer structure and normally works in horizontal state; at both endpoints and on the extension line of the diameter of a top-lay plate (18), there are two horizontal shafts (16 and 24) movably fitting the relative holes in the wall of said agitating vessel; the whole bottom can turn around said horizontal shafts (16 and 24) namely the x-axis, when driven by the torque of a rocker (19) fixed at the end of said horizontal shaft (16) which extends out of said agitating vessel; an expansion aligning pin (21) on the other end of said rocker (19) matches up a fixed pinhole pedestal (20) on the outside of said agitating vessel to fix said agitating vessel bottom; a vertical shaft (25) mounted in the center of the undersurface of said top-layer plate (18) moveably fits the holes in a middle-layer plate (28) and a bottom-layer plate (27); said middle-layer plate (28) and said bottom-layer plate (27) driving each other by the stoppers on them; said bottom-layer plate (27) is magnetic and a rotating magnetic ring (23) mounted on an extruding element (22) correspondingly along the outside of said agitating vessel can turn round the z-axis; a scraper (13) in similar shape of inner wall of said agitating vessel is mounted inside of said agitating vessel (12); said scraper (13) moveably fitting the inner wall of said agitating vessel can turn around the z-axis in a close way; said scraper (13) is magnetic and correspondingly outside of said agitating vessel (12) is a protruding element (8), on which is disposed a magnetic ring (7) that can turn around the z-axis; said transmission set inside said agitating vessel is sealed by a belt cover (10); and the joints of said agitating shaft (14) and said belt cover (10) are sealed by a packing material (29) and joints of said horizontal shaft (16) and walls of said agitating vessel are sealed by a seal material (17).

2. The agitator for the feed industry of claim 1, wherein the external circle of said agitating shaft (14) has a moveable concave-convex fit with the inside holes of said handwheel shaft liner (2), which has a bottom face covered with single-side skewed teeth; said agitating shaft (14) and said handwheel shaft liner (2) form the moveable teeth of the claw clutch; the external circle of said agitating shaft (14) has a stationary fit with the inside holes of said shaft liner (3), which has a top face covered with single-side skewed teeth; said agitating shaft (14) and said shaft liner (3) form the fixed teeth of said claw clutch; and one blocking plate connects said agitating shaft (14) by threaded connection.

3. The agitator for the feed industry of claim 1, wherein an agitating head (15) in form of one regular cone with a fan-shaped bottom connects said agitating shaft (14) in a concave-convex fit by a spacer.

4. The agitator for the feed industry of claim 1, wherein the upper half of said agitating vessel (12) is in the shape of a cylinder barrel and the lower half in the shape of circular-truncated-cone barrel; and an apex angle is less than 60 degrees.

5. The agitator for the feed industry of claim 1, wherein at both endpoints and on the extension line of the diameter of said top-layer plate (18), there are respectively said horizontal shafts 16 and 24, whose axes are within the same plane of upper surface of said top-layer plate; said horizontal shafts have a moveable fit with the relevant holes in the walls of said agitating vessel; said top-layer plate (18) has a center hole; said horizontal shafts (16, 24) can be made into a whole body with said top-layer plate 18, or firmly connect it by means of welding, threaded connection, adhesive binding, or a transition part.

6. The agitator for the feed industry of claim 1, wherein a rocker (19) is fixed at the end of said horizontal shaft (16) which extends out of said agitating vessel; and an expansion aligning pin (21) on the other end of said rocker (19) matches up a fixed pinhole pedestal (20) on the outside of said agitating vessel to fix said agitating vessel bottom.

7. The agitator for the feed industry of claim 1, wherein a hollow vertical shaft (25) is mounted in the bottom center of said top-layer plate (18); intruding step or an intruding element is fixed on said vertical shaft (25); said vertical shaft (25) can be made into a united body with said top-layer plate (18), or firmly connect it by means of welding, threaded connection, adhesive binding or stationary fit.

8. The agitator for the feed industry of claim 1, wherein the round center holes in said middle-layer plate (28) and said bottom-layer plate (27) and external circle of said vertical shaft (25) have a moveable fit; said middle-layer plate (28) and said bottom-layer plate (27) driving each other by the stoppers are supported by a protruding step of said vertical shaft or an protruding element fixed on said vertical shaft; and said bottom-layer plate (27) is made of magnetic material or attached to by one layer of magnetic material.

9. The agitator for the feed industry of claim 1, wherein a scraper (13) in similar shape of inner wall of said agitating vessel (12) has an upper part of thin-wall cylinder and a lower part consisting of some thin scrapers; said scraper (13) moveably fitting the inner wall of said agitating vessel can turn around the z-axis in a close way; said scraper (13) is made of magnetic material or attached to by one layer of magnetic material; on the corresponding positions of said bottom-layer plate (27) and said scraper (13) along the outside of said agitating vessel (12) are two protruding elements (8, 22), on which are two magnetic rings (7, 23) that can turn around the z-axis and have a moveable fit with the outside wall of said agitating vessel; and said magnetic rings are made of magnetic material with space set between said two rings to avoid interference.

10. The agitator for the feed industry of claim 1, wherein said transmission set inside said agitating vessel (12) is sealed by a belt cover (10); the joints of said agitating shaft (14) and said belt cover (10) are sealed by a packing material (29), and the joints of said horizontal shaft (16) and walls of said agitating vessel are sealed by a seal material (17).
